(19) United States
(12) Patent Application Publication
(10) Pub. No.: US 2025/0321390 A1
(43) Pub. Date: Oct. 16, 2025

(54) OPTO-ELECTRONIC MODULE AND METHOD OF FABRICATING AN OPTO-ELECTRONIC APPARATUS

(71) Applicant: Taiwan Semiconductor Manufacturing Company, Ltd., Hsinchu (TW)

(72) Inventors: Hsuan-Ting Kuo, Taichung City (TW); Hsiu-Jen Lin, Hsinchu County (TW)

(73) Assignee: Taiwan Semiconductor Manufacturing Company, Ltd., Hsinchu (TW)

(21) Appl. No.: 18/637,410

(22) Filed: Apr. 16, 2024

(51) Int. Cl. G02B 6/42; G02B 6/43

(52) U.S. Cl. CPC G02B 6/425; G02B 6/4292; G02B 6/43

(57) ABSTRACT

An opto-electronic module provided herein includes a package substrate; an electronic component disposed on the package substrate; optical transceivers disposed on the package substrate, arranged around the electronic component, and electrically connected to the electronic component; and a first fiber array unit attached to two of the optical transceivers, wherein a width of the first fiber array unit extends across between the two of the optical transceivers.

### BACKGROUND

In terms of IC evolution, functional density (i.e., the number of interconnected devices per chip area) has generally increased while geometry size (i.e., the smallest component (or line) that can be created using a fabrication process) has decreased. This scaling down process generally provides benefits by increasing production efficiency and lowering associated costs. Such scaling down has also increased the complexity of IC processing and manufacturing, and for these advancements to be realized, similar developments in package processing and manufacturing are needed. For example, the integration of electrical components and optical components is developed to enable higher capacities (e.g., smaller footprint) with lower power consumption and increased data speeds.

### BRIEF DESCRIPTION OF THE DRAWINGS

FIG. 1 schematically illustrates an opto-electronic module in accordance with some embodiments of the disclosure.

FIG. 2 schematically illustrates a cross sectional view of an opto-electronic module in accordance with some embodiments of the disclosure.

FIG. 3 schematically illustrates an opto-electronic module in accordance with some embodiments of the disclosure.

FIG. 4 schematically illustrates a cross sectional view of an opto-electronic module in accordance with some embodiments of the disclosure.

FIG. 5 schematically illustrates an end view of the first fiber array unit in accordance with some embodiments of the disclosure.

FIG. 6 schematically illustrates an end view of the second fiber array unit in accordance with some embodiments of the disclosure.

FIG. 7 schematically illustrates a top view of the fiber array unit in accordance with some embodiments of the disclosure.

FIG. 8 schematically illustrates a side view of the fiber array unit in accordance with some embodiments of the disclosure.

FIG. 9 schematically illustrate the process of attaching the fiber array unit to the optical transceivers in accordance with some embodiments.

FIG. 10 schematically illustrates an opto-electronic apparatus in accordance with some embodiments of the disclosure.

### DESCRIPTION OF THE EMBODIMENTS

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows can include embodiments in which the first and second features are formed in direct contact, and can also include embodiments in which additional features can be formed between the first and second features, such that the first and second features can not be in direct contact. In addition, the present disclosure can repeat reference numerals and/or letters in the various examples. This repetition is for the purpose of simplicity and clarity and does not in itself dictate a relationship between the various embodiments and/or configurations discussed.

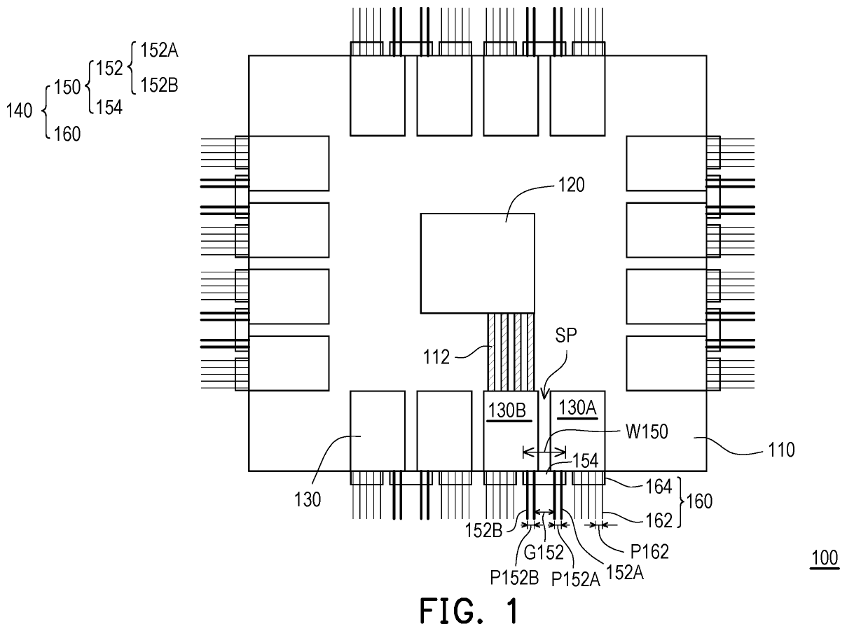

Further, spatially relative terms, such as “beneath,” “below,” “lower,” “above,” “upper” and the like, can be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus can be otherwise oriented (rotated 90 degrees or at other orientations) and the spatially relative descriptors used herein can likewise be interpreted accordingly. FIG. 1 schematically illustrates an opto-electronic module in accordance with some embodiments of the disclosure. An opto-electronic module 100 in FIG. 1 at least includes a package substrate 110, an electronic component 120, optical transceivers 130 and fiber array units 140. The electronic component 120 is disposed on the package substrate 110. The optical transceivers 130 are disposed on the package substrate 110, arranged around the electronic component 120, and electrically connected to the electronic component 120. The fiber array units 140 are attached to the optical transceivers 130. In some embodiments, the fiber array units 140 are adhered to the optical transceivers 130. In some embodiments, an adhesive used for attaching the fiber array units 140 to the optical transceivers 130 includes optical glue that is UV curable glue and substantially has no deformation after being cured.

In some embodiments, the package substrate 110 may include an organic substrate. A plurality of electric transmission paths 112 may be established in the package substrate 110 to achieve the electrical connection between the electronic component 120 and the optical transceivers 130. For illustrative purpose, FIG. 1 only schematically presents a portion of the electric transmission paths 112. The package substrate 110 may be a wiring substrate and electrically connected between the electronic component 120 and the optical transceivers 130. The electric transmission paths 112 may be formed by the conductive wirings embedded in the package substrate 110, but the disclosure is not limited thereto.

In some embodiments, the electronic component 120 can be a switch die such as a switch ASIC (Application-Specific Integrated Circuit) die and the optical transceivers 130 are arranged around the electronic component 120. Each of the optical transceivers 130 includes an optical-electrical converter for converting between optical signals and electrical signals and serves as an optical engine. The electronic component 120 is electrically connected to the optical transceivers 130. Each of the optical transceivers 130 can receive optical signals from external devices through the fiber array units 140 and converts the optical signals into electric signals that are transmitted to the electronic component 120 through the electric transmission paths 112, for example. Each of the optical transceivers 130 can receive electric signals from the electronic component 120 and converts the electric signals into optical signals that are transmitted to external devices through the fiber array units 140. In some embodiments, the optical transceivers 130 can be implemented as a semiconductor die, such as a photonic IC die.

The fiber array units 140 are configured to transmit optical signals/power into or from the optical transceivers 130. In the embodiment, the fiber array units 140 may include two types, wherein one type of the fiber array units 140 may be used for transmitting optical power and the other type of the fiber array units 140 may be used for transmitting optical data signals. For example, the first fiber array unit 150 among the fiber array units 140 is used for transmitting optical power and the second fiber array unit 160 among the optical array units 140 is used for transmitting optical data signals.

Each of the first fiber array units 150 is attached to two of the optical transceivers 130. Therefore, two of the optical transceivers 130 share one first fiber array unit 150. In FIG. 1, each side of the package substrate 110 is arranged with four optical receivers 130 and every two adjacent optical receivers 130 share one first fiber array 150, but the number of the optical receivers 130 is not limited thereto. In addition, for descriptive purpose, some of the descriptions in the disclosure may describe the optical transceiver 130A and the optical transceiver 130B indicated in FIG. 1 as examples. It is noted that the descriptions for the optical transceiver 130A and the optical transceiver 130B may refer to other optical transceivers 130.

As shown in FIG. 1, the optical transceiver 130A and the optical transceiver 130B share one first fiber array unit 150. In addition, two second fiber array units 160 are attached to the optical transceiver 130A and the optical transceiver 130B, respectively, and the two second fiber array units 160 are arranged at opposite sides of the first fiber array unit 150. In the embodiment, a width W150 of the first fiber array unit 150 extends across between the two of the optical transceivers 130, the optical transceiver 130A and the optical transceiver 130B. The first fiber array unit 150 may include optical fibers 152 and a couple member 154 assembling the optical fibers 152 in a unit. In some embodiments, the optical fibers 152 assembled in the first fiber array unit 150 includes first optical fibers 152A optically communicated to one of the two of the optical transceivers 130, e.g. the optical transceiver 130A, and second optical fibers 152B optically communicated to the other of the two of the optical transceivers 130, e.g. the optical transceiver 130B. The couple member 154 is attached to both the optical transceiver 130A and the optical transceiver 130B. The couple member 154 may overlap the space SP between the optical transceiver 130A and the optical transceiver 130B. The first fiber array unit 150 is dedicatedly used for transmitting optical power output from a laser source. The optical fibers 152 in the first fiber array unit 150 are polarization-maintaining optical fibers.

The first optical fibers 152A among the optical fibers 152 are configured to be optically communicated to the optical transceiver 130A and the second optical fibers 152B among the optical fibers 152 are configured to be optically communicated to the optical transceiver 130B that is located beside the optical transceiver 130A. In some embodiments, the couple member 154 determines the arrangement of the first optical fibers 152A and the second optical fibers 152B so that one of the first optical fibers 152A most adjacent to the second optical fibers 152B is spaced from one of the second optical fibers 152B most adjacent to the first optical fibers 152A by a gap G152. In some embodiments, the gap G152 between a tip of the first optical fiber 152A and a tip of the second optical fiber 152B may be greater than the space SP between the two of the optical transceivers 130, i.e. the optical transceiver 130A and the optical transceiver 130B. In some embodiments, the first optical fibers 152A are arranged in a pitch P152A that is corresponding to the pitch design of the light receiving structure in the optical transceiver 130A. In some embodiments, the pitch P152A of the first optical fibers 152A can be different from the gap G152. In some embodiments, the second optical fibers 152B are arranged in a pitch P152B that is corresponding to the pitch design of the light receiving structure in the optical transceiver 130B. In some embodiments, the pitch P152B of the second optical fibers 152B can be different from the gap G152. In some embodiments, the pitch P152B of the second optical fibers 152B can be different from the pitch P152A of the first optical fibers 152A. In some embodiments, the pitch P152B of the second optical fibers 152B can be identical to the pitch P152A of the first optical fibers 152A.

Each of the second fiber array units 160 includes optical fibers 162 and a couple member 164 assembling the optical fibers 162 in a unit. The couple member 164 of the second fiber array unit 160 is attached to one optical transceiver 130A or 130B. The second fiber array unit 160 is positioned further away from the space SP between the optical transceiver 130A and the optical transceiver 130B than the first fiber array unit 150. The second fiber array unit 160 is configured to transmit the optical data signals to or from the optical transceiver 130A or 130B and the optical fibers 162 assembled by the couple member 164 are single mode optical fibers. In some embodiments, the second optical fibers 162 are arranged in a pitch P162 that is corresponding to the pitch design of the light receiving structure in the corresponding optical transceiver 130.

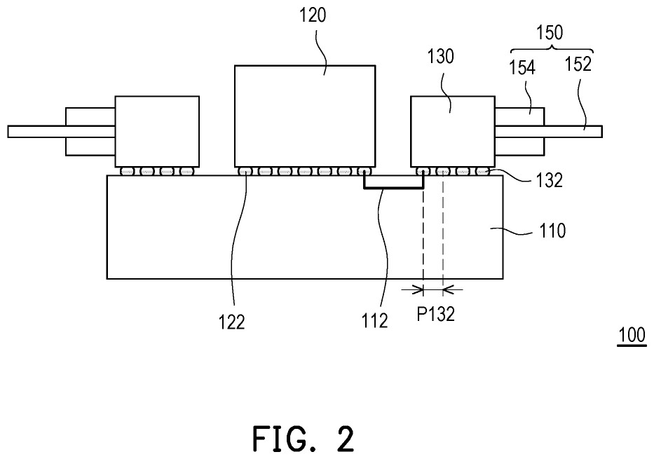

FIG. 2 schematically illustrates a cross sectional view of an opto-electronic module in accordance with some embodiments of the disclosure. The opto-electronic module 100 shown in FIG. 2 may be served as an implemental embodiment of the opto-electronic module 100 of FIG. 1 and thus the same reference numbers shown in the two drawings can refer to the same components or refer to the components that substantially involve equivalent function. As shown in FIG. 2, for descriptive purpose, the drawing presents the package substrate 110, the electronic component 120, two optical transceivers 130 and two corresponding first fiber array units 150 while other components in FIG. 1 are omitted. The electronic component 120 is bonded to the package substrate 110 through conductor bumps 122 and the optical transceivers 130 are bonded to the package substrate 110 through conductor bumps 132. In addition, the electronic component 120 can be electrically connected to the optical transceivers 130 through the electric transmission paths 112 of the package substrate 110. In the embodiment, some details of each component are omitted since FIG. 2 intends to present the dispose relationship between the components. In some embodiments, the electronic component 120 can include electronic elements such as transistors or the like therein and the package substrate 110 can include conductive wirings formed by metal or metallic materials therein.

In some embodiments, the conductor bumps 132 can be arranged in a pitch P132. In some embodiments, the pitch P132 of the conductor bumps 132 can be less than 100 microns, for example about 50-80 microns. In some embodiments, the pitch P132 of the conductor bumps 132 can be smaller than the pitch P152A/P152B (shown in FIG. 1) of the corresponding optical fibers 152 communicated the optical transceiver 130. For example, the pitch P152A/P152B of the optical fibers 152 can be about 1.5 times of the pitch P132 of the conductor bumps 132, but the disclosure is not limited thereto.

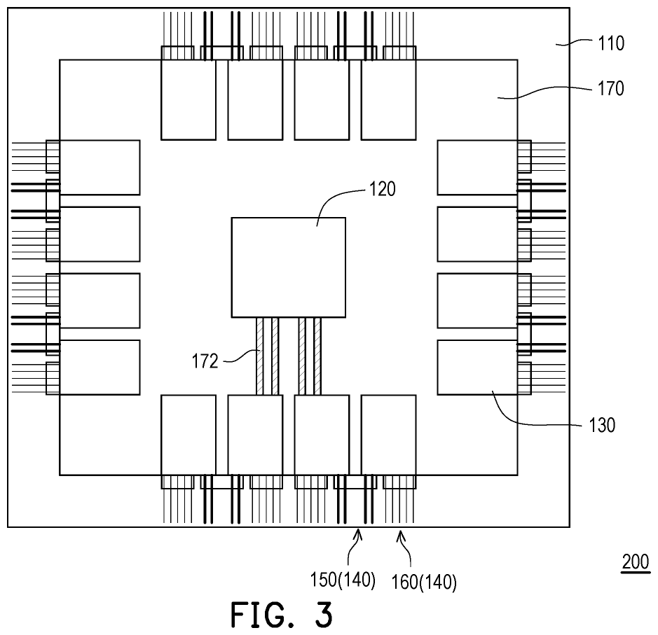

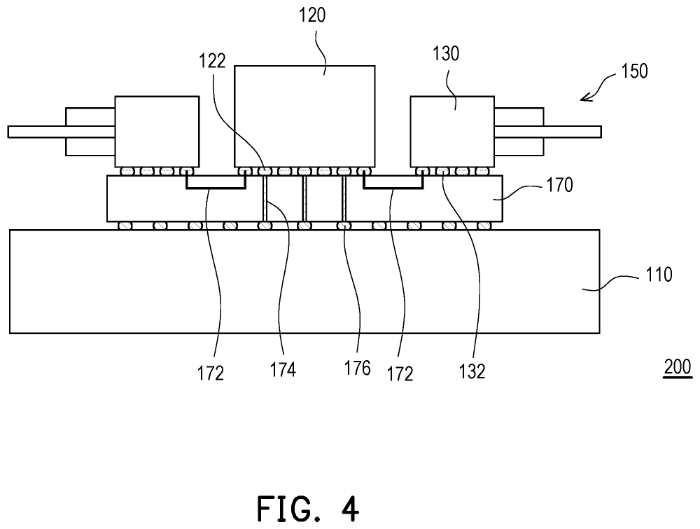

FIG. 3 schematically illustrates an opto-electronic module in accordance with some embodiments of the disclosure and FIG. 4 schematically illustrates a cross sectional view of an opto-electronic module in accordance with some embodiments of the disclosure. An opto-electronic module 200 shown in FIG. 3 and FIG. 4 is similar to the opto-electronic module 100 in FIG. 1 and FIG. 2 and the same reference numbers in these embodiments may refer to the same components or the components that substantially involve equivalent functions. The opto-electronic module 200 includes a package substrate 110, an electronic component 120, optical transceivers 130, fiber array units 140 and an interposer substrate 170. The package substrate 110 can be an organic substrate with conductive wirings embedded therein to establish electric transmission paths, but the disclosure is not limited thereto. The interposer substrate 170 is disposed on the package substrate 110 and is bonded to the package substrate 110. The electronic component 120 is disposed on and bonded to the interposer substrate 170 through conductor bumps 122. The optical transceivers 130 are disposed on and boned to the interposer substrate 170 through conductor bumps 132. The fiber array units 140 are attached to the optical transceivers 130 and optically communicated to the optical transceivers 130. Similar to the previous embodiments, the fiber array units 140 includes first fiber array units 150 each of which is attached to two optical transceivers 130 and second fiber array units 160 each of which is attached to one of the optical transceivers 130. In some embodiments, the conductor bumps 122 and the conductor bumps 132 can be micro bumps, conductor pillars, or other types of interconnection components. In some embodiments, an underfill can be formed between the electronic component 120 and the interposer substrate 170 to seal the conductor bumps 122. In some embodiments, an underfill can be formed between the optical transceivers 130 and the interposer substrate 170 to seal the conductor bumps 132.

The interposer substrate 170 can be a silicon substrate with a redistribution wiring structure thereon. The redistribution wiring structure of the interposer substrate 170 provides electric transmission paths 172 that electrically connect between the electronic component 120 and the optical transceivers 130. In some embodiments, the interposer substrate 170 further includes through substrate vias 174 establishing the electric transmission between two opposite sides of the interposer substrate 170. In addition, the interposer substrate 170 is bonded to the package substrate 110 through conductor bumps 176. Accordingly, the electronic component 130 can be electrically connected to the package substrate 110 through the through substrate vias 176 and the conductor bumps 176. The redistribution wiring structure of the interposer substrate 170 is formed using semiconductor manufacturing process. The electric transmission path 172 can be arranged in a small pitch so that the electrical transmission density provided by the interposer substrate 170 is high for achieving higher capacity.

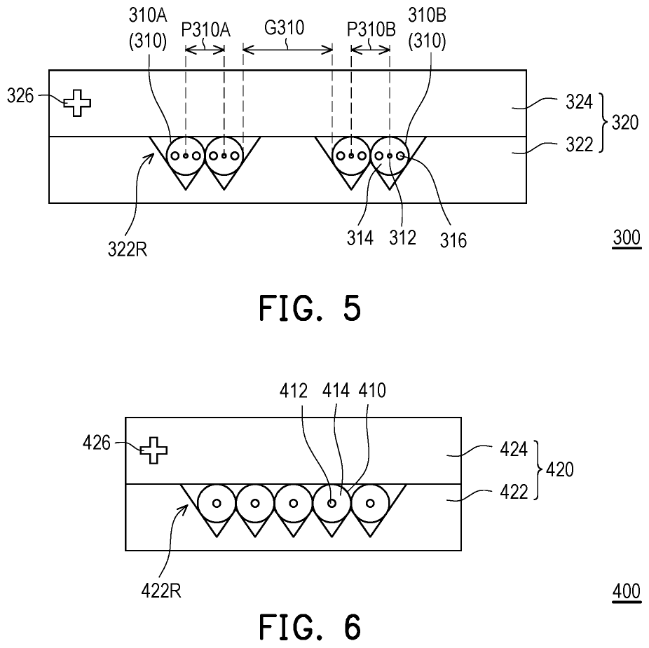

FIG. 5 schematically illustrates an end view of the first fiber array unit in accordance with some embodiments of the disclosure. A first fiber array unit 300 shown in FIG. 5 includes optical fibers 310 and a couple member 320 assembling the optical fibers 310 in a unit. In the embodiment, the first fiber array unit 300 can be applicable to the opto-electronic module 100 shown in FIGS. 1 and 2 as well as the opto-electronic module 200 shown in FIGS. 3 and 4. For example, the first fiber array unit 300 can be considered as an implemental example of the first fiber array units 150 depicted in the previous embodiments, but the disclosure is not limited thereto. The couple member 320 includes a pedestal 322 accommodating the optical fibers 310 and a cover 324 covering the optical fibers 310. The optical fibers 310 are sandwiched between the pedestal 322 and the cover 324. In some embodiments, the pedestal 320 is provided with grooves 322R formed by a cutting/grinding process. The optical fibers 310 are disposed on the pedestal 322 and respectively placed inside the grooves 322R. In some embodiments, the cover 324 is attached to and assembled with the pedestal 322 through a bonding agent (not shown). In some embodiments, the couple member 320 further includes one or more alignment mark 326. The alignment mark 326 can be formed on either the cover 324 or the pedestal 322. The shape of the alignment mark 326 can be determined based on various designs.

In the first fiber array unit 300, each of the optical fibers 310 can include a core 312, a cladding layer 314 and a pair of stress rods 316. The optical fibers 310 can be polarization-maintaining optical fibers. The core 312 and the stress rods 316 are encapsulated by the cladding layer 314. The core 312 is positioned between the stress rods 316. In some embodiments, a diameter of the core 312 may be 9 microns to 10 microns and a diameter of the cladding layer 314, i.e. the diameter of the optical fiber 310 may be about a bit more than 100 microns, for example, about 125 microns. The optical fibers 310 can be assembled in the first fiber array unit 300 in a prescribed orientation to maintain a linear polarization during propagation. In some embodiments, the cladding layer 314 at the end portion of each optical fiber 310 can removed and the core 312 at the end portion of each optical fiber 310 is placed on the corresponding groove 322R. In some embodiments, the grooves 322R may be formed in a prescribed pitch and size so that the optical fibers 310 can be arranged in the predetermined pitch. In the embodiment, the optical fibers 310 assembled in the first fiber array unit 300 are arranged in one row, but the disclosure is not limited thereto. In some embodiments, the optical fibers 310 assembled in the first fiber array unit 300 can be arranged in two or more rows.

In some embodiments, the optical fibers 310 can be divided into two groups, one of the groups includes the first optical fibers 310A and the other of the groups includes the second optical fibers 310B. The first optical fibers 310A and the second optical fibers 310B are leant against the grooves 322R. The grooves 322R are so arranged that a gap G310 between a tip of the first optical fibers 310A and a tip of the second optical fibers 310B is provided and the gap G310 is substantially corresponding to the space SP between two optical transceivers 130 shown in FIGS. 1 and 3 and the gap G152 between the first optical fibers 152A and the second optical fibers 152B when being applicable to the previous embodiments. The first optical fibers 310A may be arranged in a pitch P310A and the second optical fibers 310B may be arranged in a pitch P310B. In some embodiments, the pitch P310A and the pitch P310B may be identical or different. In some embodiments, the pitch P310A/P310B may be 127 microns±1 microns. In some embodiments, the gap G310 can be greater than the pitch P310A/P310B.

FIG. 6 schematically illustrates an end view of the second fiber array unit in accordance with some embodiments of the disclosure. A second fiber array unit 400 shown in FIG. 6 includes optical fibers 410 and a couple member 420 assembling the optical fibers 410 therein. In the embodiment, the second fiber array unit 400 can be applicable to the opto-electronic module 100 shown in FIGS. 1 and 2 as well as the opto-electronic module 200 shown in FIGS. 3 and 4. For example, the second fiber array unit 400 can be considered as an implemental example of the second fiber array units 160 depicted in the previous embodiments, but the disclosure is not limited thereto.

In the embodiment, the couple member 420 includes a pedestal 422 accommodating the optical fibers 410 and a cover 424 covering the optical fibers 410. The optical fibers 410 are single mode optical fibers. Each of the optical fibers 410 includes a core 412 and a cladding layer 414 encapsulating the core 412. In some embodiments, a diameter of the core 412 may be 9 microns to 10 microns and a diameter of the cladding layer 414, i.e. the diameter of the optical fiber 410 may be about a bit more than 100 microns, for example, about 125 microns. The pedestal 422 has grooves 422R accommodating the optical fibers 412 and the cover 424 covers the optical fibers 412 leant against the grooves 422R. In some embodiments, the cover 424 is attached to and assembled with the pedestal 422 through a bonding agent (not shown). In some embodiments, the couple member 420 further includes one or more alignment mark 426. The alignment mark 426 can be formed on either the cover 424 or the pedestal 422. The shape of the alignment mark 426 can be determined based on various designs.

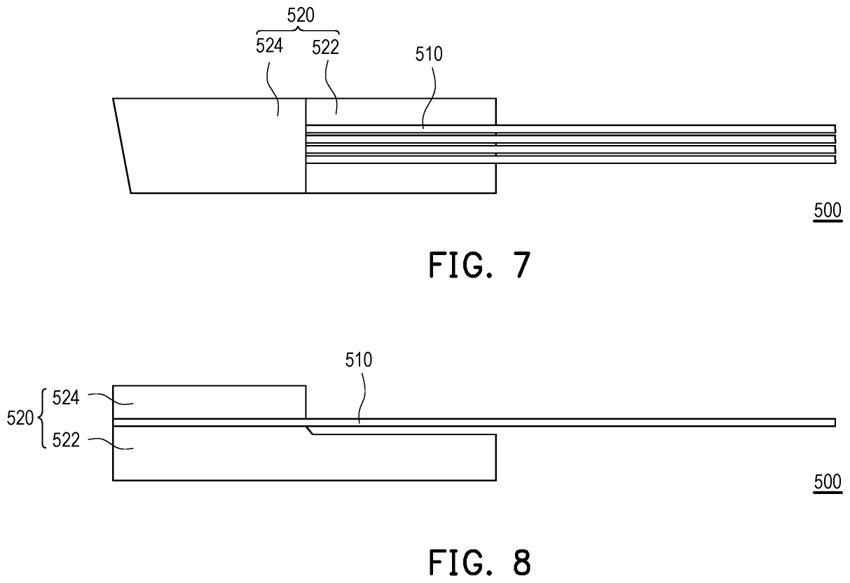

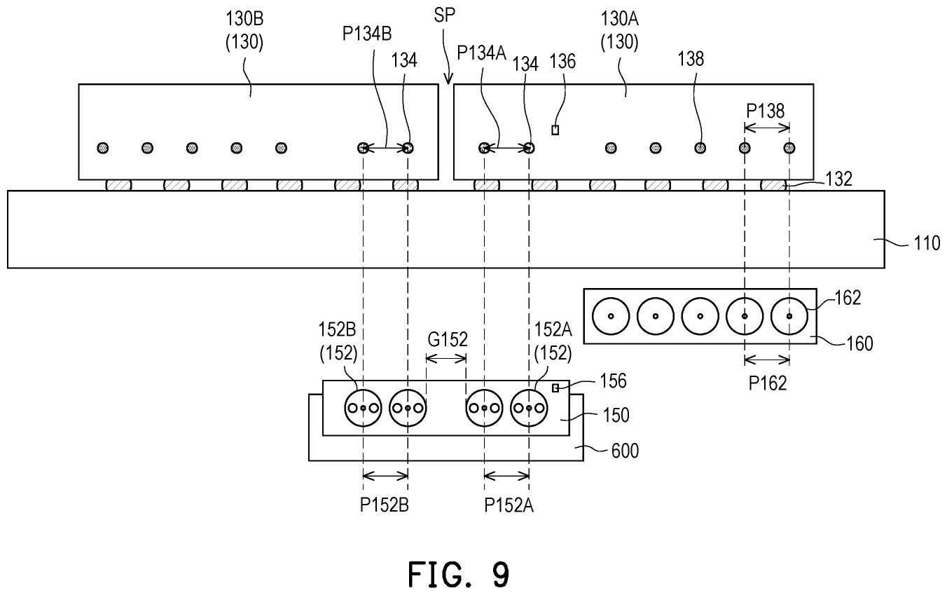

FIG. 7 schematically illustrates a top view of the fiber array unit in accordance with some embodiments of the disclosure and FIG. 8 schematically illustrates a side view of the fiber array unit in accordance with some embodiments of the disclosure. In FIG. 7 and FIG. 8 a fiber array unit 500 includes optical fibers 510 and a couple member 520 assembling the optical fibers 510 in a unit. The fiber array unit 500 may be considered as an implemental example of the fiber array units 140 depicted in the previous embodiments. The couple member 520 includes a pedestal 522 and a cover 524 covering the optical fibers 510. The optical fibers 510 arranged in an array or a row between the pedestal 522 and the cover 524. In some embodiments, the terminal of the fiber array unit 500 may be oblique as shown in FIG. 7, but the disclosure is not limited thereto. In some embodiments, the couple member 520 can be transparent, but the disclosure is not limited thereto.

FIG. 9 schematically illustrate the process of attaching the fiber array unit to the optical transceivers in accordance with some embodiments. For descriptive purpose, the reference numbers in FIG. 9 may refer the those depicted in FIG. 1 to direct to the corresponding components. In FIG. 9, the optical transceiver 130A and the optical transceiver 130B are bonded to the package substrate 110, for example, through the conductor bumps 132. Each of the optical transceivers 130A and 130B can include waveguides 134 for receiving the optical power transmitted from the optical fibers 152 assembled in the first fiber array unit 150. In some embodiments, the optical fibers 152 assembled in the first fiber array unit 150 is configured to transmit optical power and can be polarization-maintaining optical fibers.

In some embodiments, the terminals of the waveguides 134 formed in the optical transceiver 130A can be arranged in a pitch P134A and the terminals of the waveguides 134 formed in the optical transceiver 130B can be arranged in a pitch P134B. The first optical fibers 152A predetermined to optically communicate to the optical transceiver 134A can be arranged in a pitch P152A and the second optical fibers 152B predetermined to optically communicate to the optical transceiver 134B can be arranged in a pitch P152B. The pitch P134A and the pitch P152A can be substantially identical and the pitch P134B and the pitch P152B can be substantially identical. In some embodiments, the group of the first optical fibers 152A and the group of the second optical fibers 152B are spaced by a gap G152 and the gap G152 is corresponding to the space SP between the optical transceiver 130A and the optical transceiver 130B.

In some embodiments, one or more alignment mark 136 can be formed on the optical transceivers 130 and one or more alignment mark 156 can be formed on the first fiber array unit 150. In some embodiments, the first fiber array unit 150 is hold and carried by a tool 600. The tool 600 moves the first fiber array unit 150 towards the optical transceiver 130A and the optical transceiver 130B by moving the alignment mark 156 proximate to the alignment mark 136. In some embodiments, an optical power meter (not shown) is utilized to measure the intensity of the optical power transmitting in the first optical fibers 152. The tool 600 moves the first fiber array unit 150 to adjust the position of the first fiber array unit 150 while the optical power meter is measuring. The tool 600 stops the first fiber array unit 150 at an attaching position when an optimized result is measured by the optical power meter. For example, the measured values indicate that the optical power transmitting in all of the first optical fibers 152 are optimized. Then, attaching the first fiber array unit 150 to the optical transceiver 130A and the optical transceiver 130B at the attaching position. In some embodiments, the first fiber array unit 150 is adhered to the optical transceiver 130A and the optical transceiver 130B through an optical glue that has negligible volume change/deformation after being cured. In some embodiments, the first fiber array unit 150 is attached to the optical transceiver 130A and the optical transceiver 130B through pluggable mechanical members.

In some embodiments, the second fiber array unit 160 may be attached to the optical transceivers 130A and 130B in a similar method. For example, each of the optical transceivers 130A and 130B includes wave guides 138 for transmitting the optical data signals from and to the optical fibers 162 assembled in the second fiber array unit 160. The pitch P162 of the optical fibers 162 and the pitch P138 of the receiving terminals of the wave guides 138 may be identical. A tool similar to the tool 600 can carry the second optical fiber unit 160 to an optimized position and the second fiber array unit 160 can be attached to the optical transceiver 130 at the optimized position.

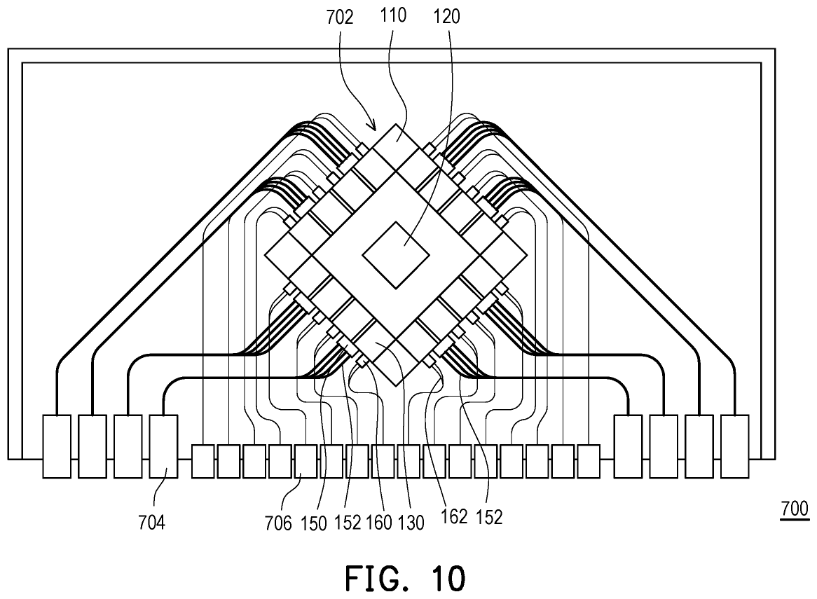

FIG. 10 schematically illustrates an opto-electronic apparatus in accordance with some embodiments of the disclosure. An opto-electronic apparatus 700 at least includes a co-packaged optics 702, first fiber array units 150 attaching to the co-packaged optics 702 and a laser source 704 optically communicating to the first fiber array unit 150. The opto-electronic apparatus 700 can further includes second fiber array units 160 attaching to the co-packaged optics 702 and the connectors 706 optically communicating to the second fiber array unit 160. In some embodiments, a method of fabricating an opto-electronic apparatus 700 includes providing a co-packaged optics 702 including an electronic component 120 and optical transceivers 130 electrically connected to the electronic component 120; attaching a first fiber array unit 150 to two of the optical transceivers 130, wherein a width of the first fiber array unit 150 extends across between the two of the optical transceivers 130; and arranging a laser source 704. Optical fibers assembled in the first fiber array unit 150 are optically connected between the laser source 704 and the two of the optical transceivers 130.

In some embodiments, the connectors 706 are fiber optical connectors such as multi-lane optical connectors. In some embodiments, the co-packaged optics 702 includes a package substrate 110, an electronic component 120 disposed on the package substrate 110 and optical transceivers 130 disposed on the package substrate 110. The electronic component 120 is electrically connected to the optical transceivers 130. Each of the first fiber array unit 150 is attached to two of the optical transceivers 130. A width of the first fiber array unit 150 extends across between the two of the optical transceivers 130. In addition, each of the second fiber array units 160 is attached to one of the optical transceivers 130. The co-packaged optics 702, the first fiber array units 150 and the second fiber array units 160 can be considered as the opto-electronic module 100 in FIGS. 1 and 2 or the opto-electronic module 200 in FIGS. 3 and 4.

In the embodiment, optical fibers 152 assembled in the first fiber array unit 150 are optically connected between the laser source 704 and the corresponding two of the optical transceivers 130. Therefore, the optical fibers 152 in the first fiber array unit 150 are configured to transmit the optical power. In some embodiments, the optical fibers 152 in the first fiber array unit 150 are polarization-maintaining optical fibers. In some embodiments, optical fibers 162 assembled in the second fiber array unit 160 are connected to one of the connectors 706. For example, optical fibers 162 assembled in the second fiber array unit 160 are connected to the connector 706. The optical fibers 162 assembled in the second fiber array unit 160 are configured to transmit optical signals such as data signals. The optical fibers 162 assembled in the second fiber array unit 160 are single mode optical fibers.

Each of the first fiber array units 150 assembles only the polarization-maintaining optical fibers in a unit and is configure to transmit the optical power from one laser source to two optical transceivers 130. Each of the second fiber array units 160 assembles only the single mode optical fibers for transmitting the optical data signal. Accordingly, dedicated fiber array units are provided for the optical communication. The fabrication yield of the second fiber array units 160 is high since the optical fibers 162 assembled therein are single mode optical fibers that require less alignment precision. The fabrication cost is also reduced since the yield rate is high.

In view of the above, the opto-electronic module in accordance with some embodiments of the disclosure includes dedicated fiber array units for transmitting optical power to the optical transceivers and two of the optical transceivers share one dedicated fiber array unit for transmitting optical power. Therefore, the transmission routings for optical power are simplified. The opto-electronic module in accordance with some embodiments of the disclosure further includes dedicated fiber array units for transmitting optical data signals. The fiber array units for transmitting optical data signals assembling the single mode optical fibers can be fabricated efficiently, which helps to reduce the cost of fabricating the fiber array units.

In some embodiments of the disclosure, an opto-electronic module includes a package substrate; an electronic component disposed on the package substrate; optical transceivers disposed on the package substrate, arranged around the electronic component, and electrically connected to the electronic component; and a first fiber array unit attached to two of the optical transceivers, wherein a width of the first fiber array unit extends across between the two of the optical transceivers. In some embodiments, optical fibers assembled in the first fiber array unit are polarization-maintaining optical fibers. In some embodiments, optical fibers assembled in the first fiber array unit includes first optical fibers optically communicated to one of the two of the optical transceivers and second optical fibers optically communicated to the other of the two of the optical transceivers. One of the first optical fibers most adjacent to the second optical fibers is spaced from one of the second optical fibers most adjacent to the first optical fibers by a gap across between the two of the optical transceivers. The first optical fibers are arranged in a pitch different from the gap. The second optical fibers are arranged in a pitch different from the gap. The opto-electronic module further includes a second fiber array unit attached to one of the optical transceivers. Optical fibers assembled in the second fiber array unit are single mode optical fibers. The opto-electronic module further includes an interposer substrate, the electronic component and the optical transceivers are disposed on the interposer substrate and the interposer substrate is bonded to the package substrate.

In some embodiments of the disclosure, an opto-electronic module includes a package substrate; an electronic component disposed on the package substrate; a first optical transceiver disposed on the package substrate, and electrically connected to the electronic component; a second optical transceiver disposed on the package substrate, beside the first optical transceiver and electrically connected to the electronic component; a first optical fiber optically communicated to the first optical transceiver; a second optical fiber optically communicated to the second optical transceiver; and a couple member connected to the first optical transceiver and the second optical transceiver, wherein the first optical fiber and the second optical fiber are assembled in the couple member. In some embodiments, the first optical fiber and the second optical fiber are polarization-maintaining optical fibers. A gap between a tip of the first optical fiber and a tip of the second optical fiber is greater than a space between the first optical transceiver and the second optical transceiver. The couple member is adhered to the first optical transceiver and the second optical transceiver. The couple member comprises a pedestal and a cover, and the first optical fiber and the second optical fiber are carried by the pedestal between the pedestal and the cover. The pedestal has grooves and the first optical fiber and the second optical fiber are leant against the grooves.

In some embodiments of the disclosure, a method of fabricating an opto-electronic apparatus includes providing a co-packaged optics including an electronic component and optical transceivers electrically connected to the electronic component; attaching a first fiber array unit to two of the optical transceivers, wherein a width of the first fiber array unit extends across between the two of the optical transceivers; and arranging a laser source. Optical fibers assembled in the first fiber array unit are optically connected between the laser source and the two of the optical transceivers. The optical fibers assembled in the first fiber array unit are polarization-maintaining optical fibers. The opto-electronic apparatus further includes attaching a second fiber array unit to one of the optical transceivers. The opto-electronic apparatus further includes arranging a connector, wherein optical fibers assembled in the second fiber array unit are connected to the connector. The optical fibers assembled in the second fiber array unit are single mode optical fibers.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. An opto-electronic module, comprising:
a package substrate;
an electronic component disposed on the package substrate;
optical transceivers disposed on the package substrate, arranged around the electronic component, and electrically connected to the electronic component; and
a first fiber array unit attached to two of the optical transceivers, wherein a width of the first fiber array unit extends across between the two of the optical transceivers.

2. The opto-electronic module of claim 1, wherein optical fibers assembled in the first fiber array unit are polarization-maintaining optical fibers.

3. The opto-electronic module of claim 1, wherein optical fibers assembled in the first fiber array unit comprise first optical fibers optically communicated to one of the two of the optical transceivers and second optical fibers optically communicated to the other of the two of the optical transceivers.

4. The opto-electronic module of claim 3, wherein one of the first optical fibers most adjacent to the second optical fibers is spaced from one of the second optical fibers most adjacent to the first optical fibers by a gap across between the two of the optical transceivers.

5. The opto-electronic module of claim 4, wherein the first optical fibers are arranged in a pitch different from the gap.

6. The opto-electronic module of claim 4, wherein the second optical fibers are arranged in a pitch different from the gap.

7. The opto-electronic module of claim 1, further comprising a second fiber array unit attached to one of the optical transceivers.

8. The opto-electronic module of claim 7, wherein optical fibers assembled in the second fiber array unit are single mode optical fibers.

9. The opto-electronic module of claim 1, further comprising an interposer substrate, the electronic component and the optical transceivers are disposed on the interposer substrate and the interposer substrate is bonded to the package substrate.

10. An opto-electronic module, comprising:
a package substrate;
an electronic component disposed on the package substrate;
a first optical transceiver disposed on the package substrate, and electrically connected to the electronic component;
a second optical transceiver disposed on the package substrate, beside the first optical transceiver and electrically connected to the electronic component;
a first optical fiber optically communicated to the first optical transceiver;
a second optical fiber optically communicated to the second optical transceiver; and
a couple member connected to the first optical transceiver and the second optical transceiver, wherein the first optical fiber and the second optical fiber are assembled in the couple member.

11. The opto-electronic module of claim 10, wherein the first optical fiber and the second optical fiber are polarization-maintaining optical fibers.

12. The opto-electronic module of claim 10, wherein a gap between a tip of the first optical fiber and a tip of the second optical fiber is greater than a space between the first optical transceiver and the second optical transceiver.

13. The opto-electronic module of claim 10, wherein the couple member is adhered to the first optical transceiver and the second optical transceiver.

14. The opto-electronic module of claim 10, wherein the couple member comprises a pedestal and a cover, and the first optical fiber and the second optical fiber are carried by the pedestal between the pedestal and the cover.

15. The opto-electronic module of claim 14, wherein the pedestal has grooves and the first optical fiber and the second optical fiber are leant against the grooves.

16. A method of fabricating an opto-electronic apparatus, comprising:
providing a co-packaged optics comprising an electronic component and optical transceivers electrically connected to the electronic component;
attaching a first fiber array unit to two of the optical transceivers, wherein a width of the first fiber array unit extends across between the two of the optical transceivers; and
arranging a laser source, wherein optical fibers assembled in the first fiber array unit are optically connected between the laser source and the two of the optical transceivers.

17. The method of fabricating the opto-electronic apparatus of claim 16, wherein the optical fibers assembled in the first fiber array unit are polarization-maintaining optical fibers.

18. The method of fabricating the opto-electronic apparatus of claim 16, further comprising attaching a second fiber array unit to one of the optical transceivers.

19. The method of fabricating the opto-electronic apparatus of claim 18, further comprising arranging a connector, wherein optical fibers assembled in the second fiber array unit are connected to the connector.

20. The method of fabricating the opto-electronic apparatus of claim 19, wherein the optical fibers assembled in the second fiber array unit are single mode optical fibers.
